(19) United States
(12) Patent Application Publication
(10) Pub. No.: US 2009/0189316 A1
(43) Pub. Date: Jul. 30, 2009

(54) METHOD FOR MANUFACTURING KEYPAD HAVING THREE-DIMENSIONAL PATTERNS

(76) Inventor: Jian-Li CHANG, Taoyuan (TW)

Correspondence Address: HDLS Patent & Trademark Services, P.O. BOX 220746, CHANTILLY, VA, 20153-0746, US

(21) Appl. No.: 12/054,539

(22) Filed: Mar. 25, 2008

(30) Foreign Application Priority Data
Jan. 25, 2008 (TW) 097102775

(51) Int. Cl. B29C 35/02; B29C 59/16; B29C 39/02

(52) U.S. Cl. 264/447; 264/496

(57) ABSTRACT

In a method for manufacturing keypad having three-dimensional patterns, curable resin is filled in a mold, and a ultra-violet lamp irradiates the curable resin, thereby curing the resin. A plurality of different materials is overlapped with each other, and a coating layer is coated on the surface of each three-dimensional pattern, thereby manufacturing a key having three-dimensional patterns. Via the above arrangement, the recognition and aesthetic feeling of each three-dimensional pattern can be increased.

### BACKGROUND OF THE INVENTION

1. Field of the Invention

The present invention relates to a method for manufacturing keypad, and in particular to a method for manufacturing keypad having three-dimensional patterns.

2. Description of Prior Art

With the progress and development of technology, modern consumers request electronic products such as mobile phone, personal digital assistant (PDA), ultra-micro personal computer (UMPC) to be designed in a more personalized and delicate manner. However, these electronic products can be only operated via keypad so as to transmit signals from a user to the electronic products or vice versa. Moreover, the user requests the keypad of the electronic product to be varied continuously. Therefore, it is an important issue for the manufacturers of keypad to develop keypad of more competitiveness to satisfy the request of modern people.

Japanese Patent Publication No.2000-340059 discloses a conventional method for manufacturing keypad. According to this method, a pattern layer and a keycap layer are overlapped with each other. First, a bottom plate and three-dimensional patterns are integrally formed. The three-dimensional patterns protrude from the top surface of the bottom plate. Next, the top surface of the three-dimensional pattern is printed. Then, the three-dimensional patterns of the bottom plate are embedded in the keycap layer via a hot welding process.

Further, Japanese Patent publication No.2000-331554 discloses another method for manufacturing keypad. According to this method, cavities having three-dimensional patterns are formed in an inner surface of a keycap layer. The inner surface of the keycap layer is printed with a light-shielding film. Then, the inner surface of the cavity having three-dimensional patterns is coated with a light-transmitting colored film. In this way, the method for manufacturing keypad can be completed.

Although the above-mentioned method for manufacturing keypad can obtain keypad having three-dimensional patterns, Patent Publication No.2000-340059 only teaches a step of printing on the top surface of the three-dimensional patterns. Therefore, the whole shape of the three-dimensional pattern cannot be displayed sufficiently, and thus the recognition and aesthetic feeling thereof are not good. Further, since both the above-mentioned patent publications do not provide a light-guiding plate, the illuminated area is relatively small and thus it can be only applied to a relative small key or single key. Therefore, for a key having a large operating area, the key manufactured by the conventional methods cannot satisfy this requirement for use.

### SUMMARY OF THE INVENTION

The present invention is to provide a method for manufacturing keypad having three-dimensional patterns. With the above arrangement, patterns such as characters, symbols or icons can be displayed in the keycaps in a three-dimensional manner, thereby increasing the recognition and aesthetic feeling.

The present invention provides a method for manufacturing keypad having three-dimensional patterns, which includes the steps of:

a) preparing a first mold, and filling a first ultra-violet curable resin in the first mold;

b) disposing a shaping layer in the first mold, and overlapping the shaping layer on the first ultra-violet curable resin;

c) irradiating the first ultra-violet curable resin with an ultra-violet lamp to cure the resin to form a pattern layer, forming a plurality of three-dimensional patterns on a front surface of the pattern layer;

d) removing an assembled structure having the shaping layer and the pattern layer from the first mold;

e) coating a coating layer on a front surface of the pattern layer, thereby forming a semi-finished key;

f) preparing a second mold, and filling a second ultra-violet resin into the second mold;

g) disposing the semi-finished key in the second mold and overlapping it on the second ultra-violet curable resin; and

h) irradiating the second ultra-violet curable resin with the ultra-violet lamp to cure the resin to form a keycap layer, and forming a plurality of keycaps on a front surface of the keycap layer.

### BRIEF DESCRIPTION OF THE DRAWINGS

FIG. 1 is a flow chart showing the method for manufacturing keypad of the present invention;

FIG. 2 is an exploded perspective view showing a first mold and the shaping layer of the present invention;

FIG. 3 is a cross-sectional view showing the pattern layer of the present invention being irradiated with a ultra-violet lamp;

FIG. 4 is a schematic view showing the external appearance of the assembled structure having the pattern layer and the shaping layer of the present invention;

FIG. 5 is an assembled cross-sectional view showing the pattern layer, the shaping layer and the coating layer of the present invention;

FIG. 6 is an exploded perspective view showing a second mold and the semi-finished key of the present invention;

FIG. 7 is a cross-sectional view showing the keycap layer of the present invention being irradiated with a ultra-violet lamp;

FIG. 8 is a schematic view showing the external appearance of the key after finishing the step h) of the method of the present invention;

FIG. 9 is an exploded perspective view showing the key of FIG. 8 and a light-guiding plate;

FIG. 10 is an assembled cross-sectional view of FIG. 9;

FIG. 11 is an assembled cross-sectional view showing the assembled structure of FIG. 10 and a base layer;

FIG. 12 is an assembled cross-sectional view showing the product manufactured by the step k) of the method of the present invention;

FIG. 13 is an assembled cross-sectional view showing the product manufactured by the step l) of the method of the present invention;

FIG. 14 is an assembled cross-sectional view showing another embodiment of the key of the present invention;

FIG. 15 is an assembled view showing the key of the present invention being used in a mobile phone;

FIG. 16 is a schematic view showing the arrangement of the key of FIG. 15 and light-emitting elements;

FIG. 17 is an assembled cross-sectional view showing the state before the action of the key of FIG. 16 and the circuit board;

FIG. 18 is an assembled cross-sectional view showing the state after the action of the key of FIG. 16 and the circuit board;

FIG. 19 is an assembled schematic view showing the key of the present invention being used in a PDA;

FIG. 20 is an assembled schematic view showing the key of the present invention being used in an automobile stereo panel; and

FIG. 21 is an assembled schematic view showing the key of the present invention being used in an UMPC.

### DETAILED DESCRIPTION OF THE INVENTION

The detailed description and technical contents of the present invention will be explained with reference to the accompanying drawings. However, the drawings are illustrative only, but not used to limit the scope of the present invention.

The key having three-dimensional patterns manufactured by the present invention includes a base layer 10, a light-guiding plate 11, a pattern layer 12, a coating layer 13, a keycap layer 14, and a shaping layer 15, as shown in FIG. 11.

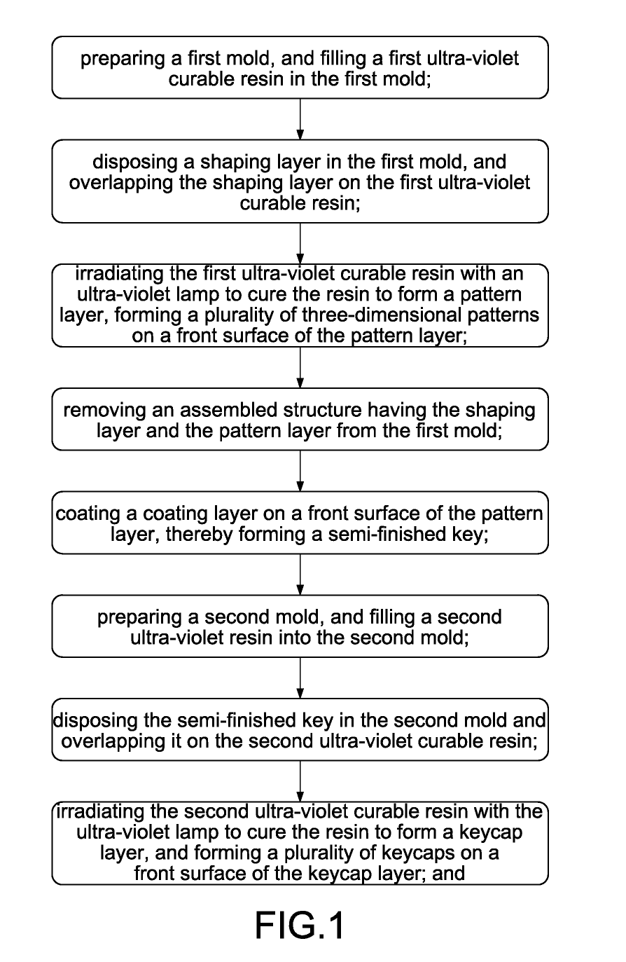

Please refer to FIGS. 1 to 8. The present invention provides a method for manufacturing keypad having three-dimensional patterns. The method includes the steps as follows.

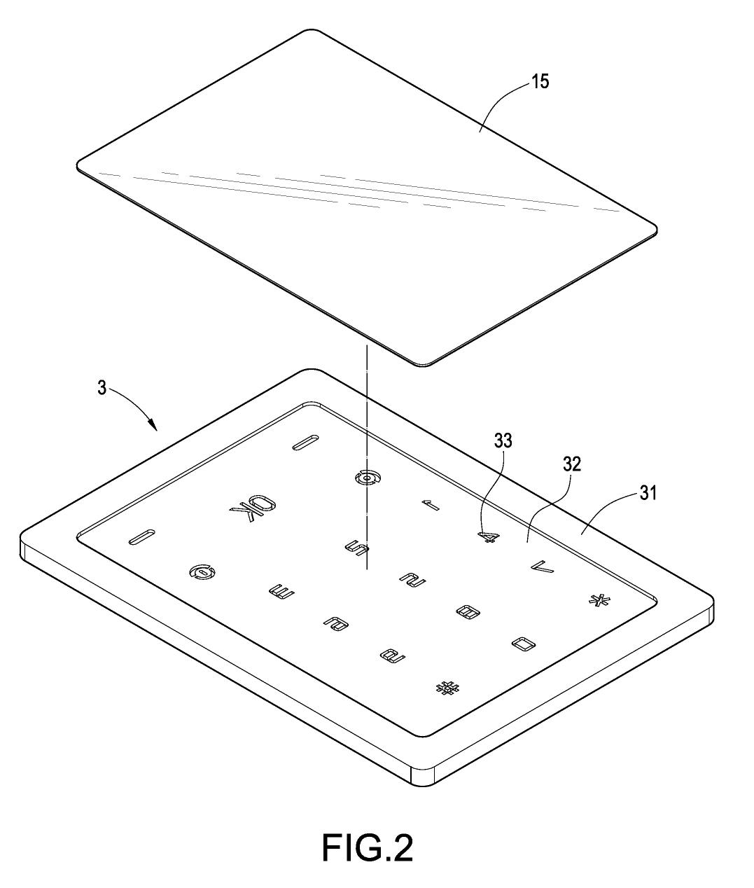

a) A first mold 3 is prepared, and a first ultra-violet curable resin in filled the first mold 3 (FIG. 2). In this step, the first mold 3 has a rectangular block 31 made of a light-transmitting material. The top of the block 31 is provided with a recess 32. The inner surface of the recess 32 is provided with a plurality of pattern cavities 33 such as characters, symbols, icons or the like. In the present embodiment, the pattern cavity 33 includes any of “0˜9”, “*”, “#”, “OK” etc., but it is not limited thereto. In manufacturing, the first ultra-violet curable resin (not shown) is filled uniformly into the recess 32 and each three-dimensional pattern cavity 33. Then, the resin is leveled by means of a pressing plate or roller (not shown).

b) A shaping layer 15 is disposed in the first mold 3, and is overlapped on the first ultra-violet curable resin as shown in FIG. 2. In this step, the shaping layer 15 can be made of any one of PET, PC or the mixture of PMMA and PC. In manufacturing, the shaping layer 15 is overlapped on the upper surface of the first ultra-violet curable resin at a position corresponding to the recess 32.

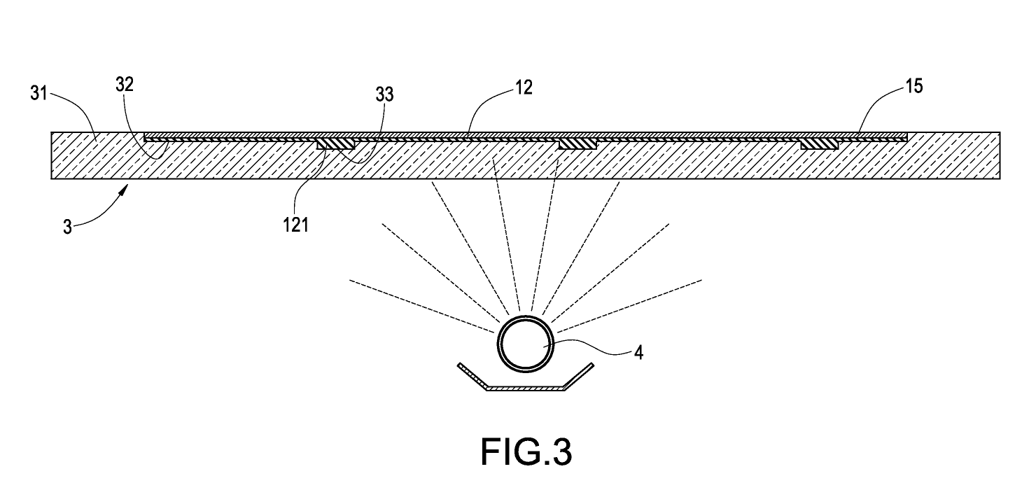

c) The first ultra-violet curable resin is irradiated with a ultra-violet lamp 4, so that the resin is cured to form a pattern layer 12. A plurality of three-dimensional patterns 121 is formed on a front surface of the pattern layer 12, as shown in FIG. 3. In this step, since the block 31 has a light-transmitting property, the underside of the block 31 can be irradiated with ultra-violet light by using the ultra-violet lamp 4. In this way, the first ultra-violet curable resin is cured to form a pattern layer 12, and a plurality of corresponding three-dimensional patterns 121 is formed in the pattern cavities 33 respectively.

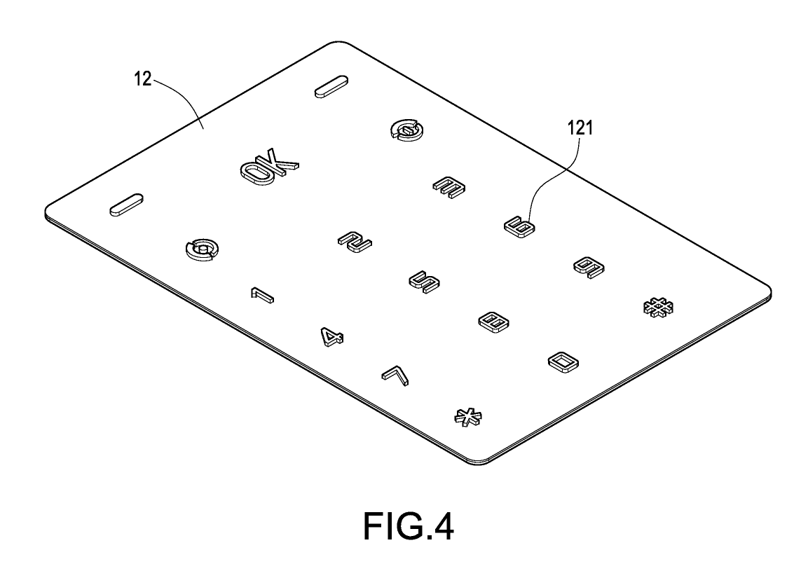

d) The assembled structure having the shaping layer 15 and the pattern layer 12 is removed from the first mold 3, as shown in FIG. 4.

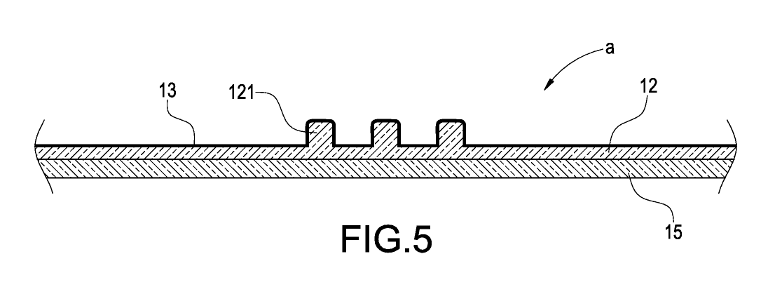

e) A coating layer 13 is coated on the front surface of the pattern layer 12, thereby forming a semi-finished key a (FIG. 5). In this step, the coating layer 13 made of metals such as Ti, Ni, Cr or the alloy thereof is coated on the front surface of the pattern layer 12 having three-dimensional patterns 121 by means of physical vapor deposition (PVD), sputtering, or multilayer coating. In this way, a semi-finished key a can be obtained. The light-transmitting property of the coating layer 13 can be controlled by the coated density of the coating materials.

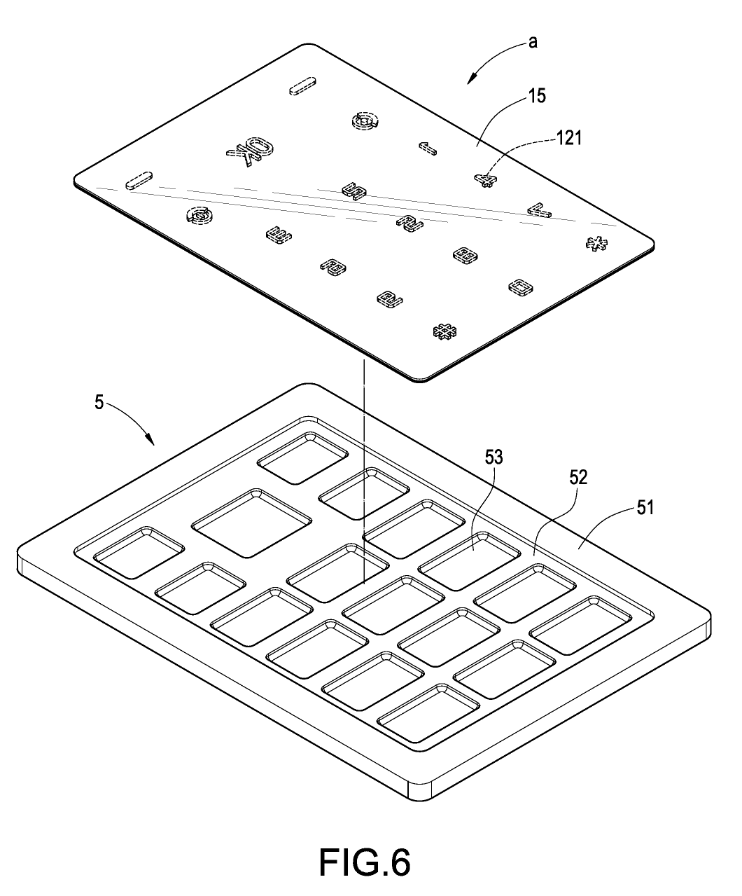

f) A second mold 5 is prepared. A second ultra-violet curable resin is filled into the second mold 5 (FIG. 6). In this step, the second mold 5 has a rectangular block 51 made of a light-transmitting material. The top of the block is provided with a recess 52. The inner surface of the recess 52 is provided with a plurality of keycap cavities 53. In manufacturing, the second ultra-violet curable resin is filled uniformly into the recess 52 and each keycap cavity 53. Then, the resin is leveled by means of a pressing plate or roller (not shown).

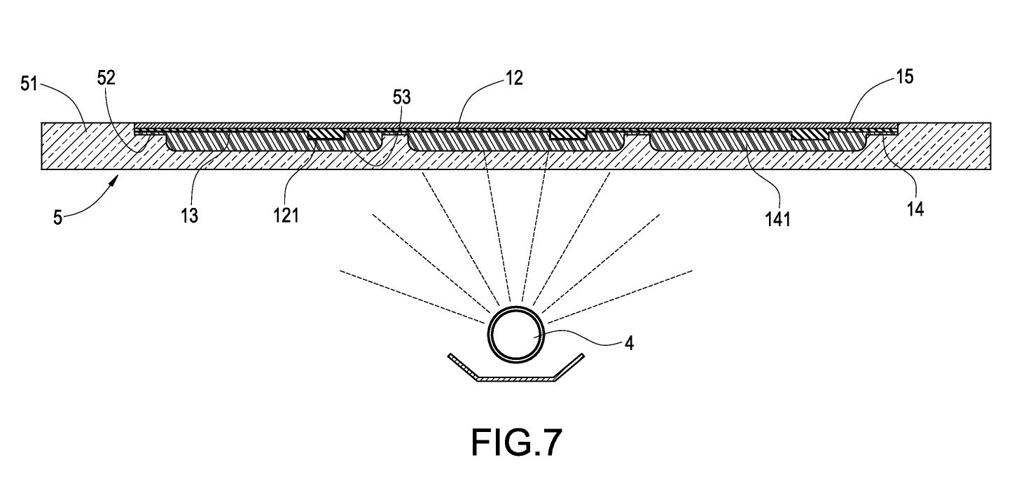

g) The semi-finished key a is disposed in the second mold 5, and is overlapped on the first ultra-violet curable resin (FIG. 7). In this step, the semi-finished key a is overlapped on the upper surface of the second ultra-violet curable resin at a position corresponding to the recess 52. In this way, each three-dimensional pattern 121 is located at a position corresponding to each keycap cavity 53, and each three-dimensional pattern 121 is embedded in the second ultra-violet curable resin.

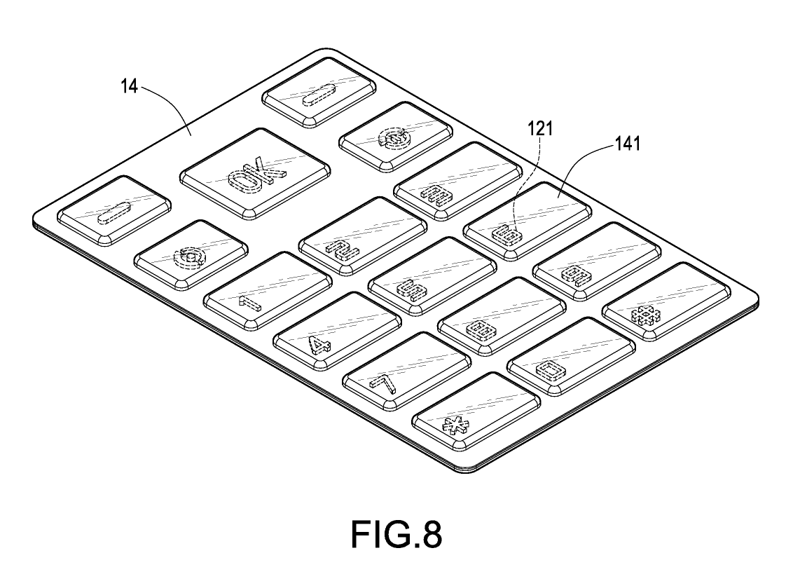

h) The second ultra-violet curable resin is irradiated with the ultra-violet lamp 4, so that the resin is cured to form a keycap layer 14. A plurality of keycaps 141 is formed on a front surface of the keycap layer 14 as shown in FIGS. 7 and 8. In this step, since the block 51 has a light-transmitting property, the underside of the block 51 is irradiated with the ultra-violet light generated by the ultra-violet lamp 4, so that the second ultra-violet curable resin can be cured to form a keycap layer 14. A plurality of keycap 141 is formed on the front surface of the keycap layer 14, and each three-dimensional pattern 121 is formed in each keycap 141. Via the above steps, the manufacturing of keypad of the present invention can be completed.

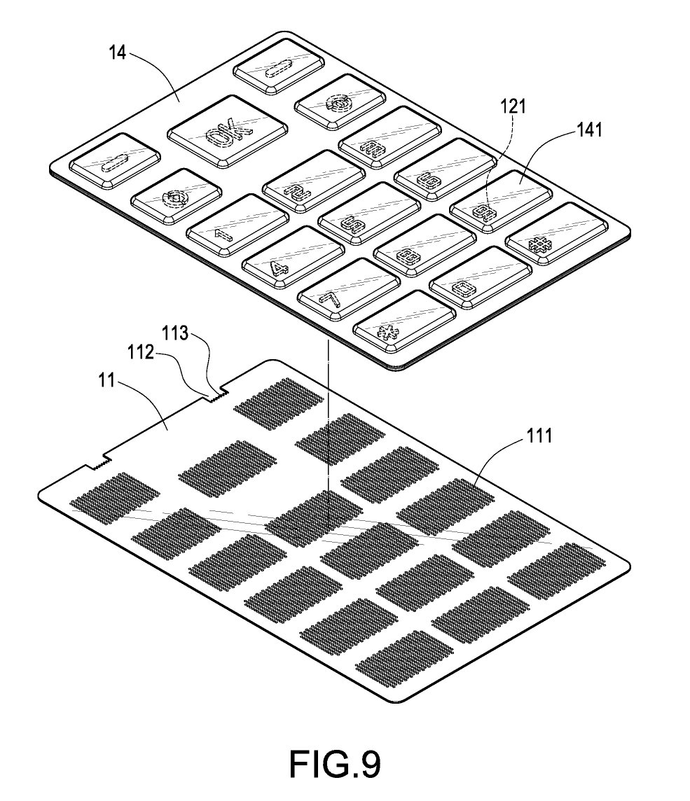

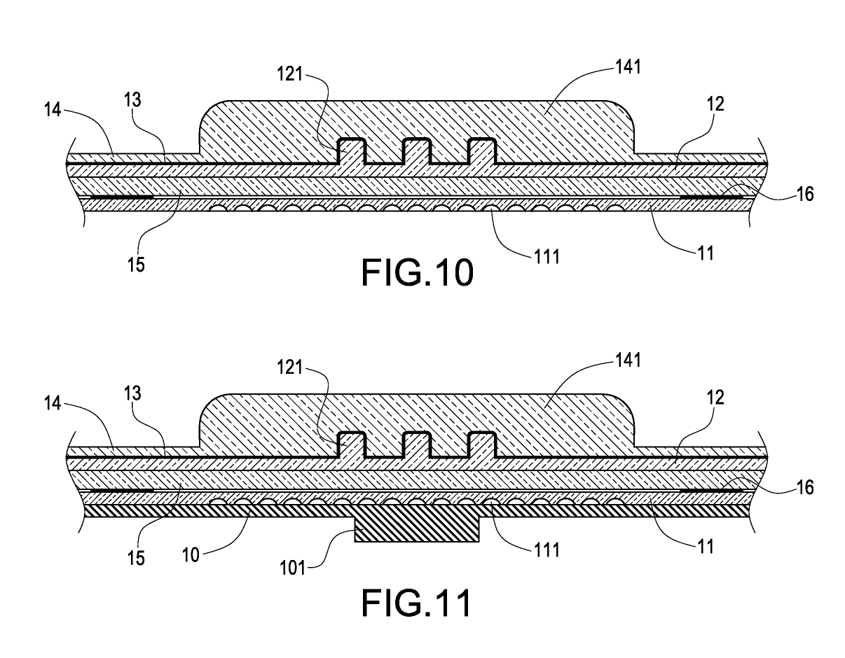

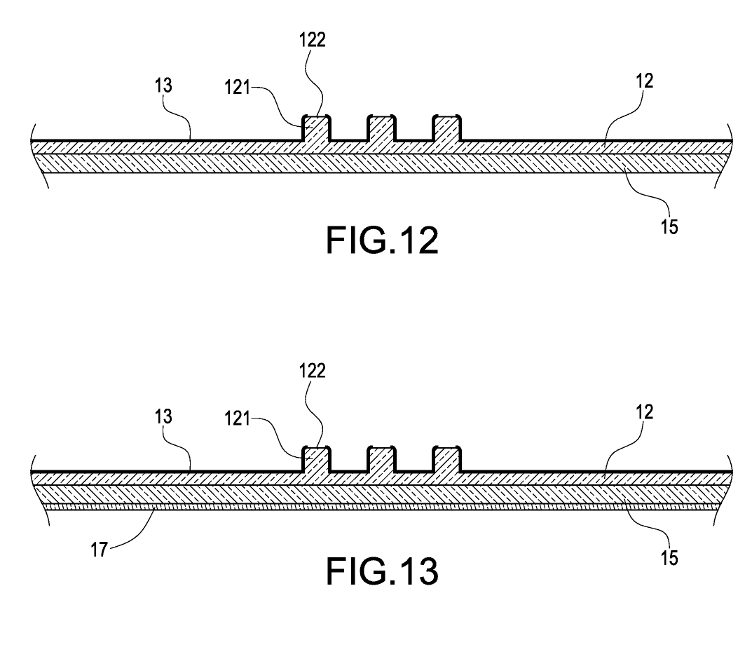

Further, the present invention includes a step i) of overlapping a light-guiding plate 11 on the back surface of the shaping layer 15 (FIGS. 9 and 10). The step i) can be performed after the step e) or the step h). In the present embodiment, it is performed after the step h). In this step, the light-guiding plate 11 is formed with a plurality of light-guiding microstructures 111 exactly beneath each keycap 141 and each three-dimensional pattern 121. The light is refracted by the light-guiding structures and emitted from the upside of the light-guiding plate 11. Further, one side of the light-guiding plate 11 is provided with two notches 112. The inner surfaces of the two notches 112 are formed with tooth-like stripes 113. In addition, a binding layer 16 (FIG. 10) is connected between the light-guiding plate 11 and the shaping layer 15. The binding layer 16 may be acrylic glue and is applied to the positions avoiding the light-guiding microstructures 111.

Further, the present invention includes a step j) of connecting a base layer 10 to the back surface of the light-guiding plate 11 by pressing (FIG. 11). In this step, the base layer 10 may be made of silicone, which is connected with the underside of the light-guiding plate 11 by means of adhesion. Alternatively, after the light-guiding plate 11 and the base layer 10 are connected with each other by means of a hot pressing process, the light-guiding plate 11 is adhered to the underside of the shaping layer 15 via the binding layer 16. Further, the lower surface of the base layer 10 is formed with bumps 101 each of which is located exactly beneath the corresponding keycap 141. Via this arrangement, the keypad of another embodiment of the present invention can be completed.

In addition to the above embodiment, the method for manufacturing keypad having three-dimensional patterns of the present invention can include a step k) performed after the step e). In the step k), the coating layer 13 on the top surface of the three-dimensional patterns 121 is formed with a highly light-transmitting region 122 by means of removing a portion of the coating layer 13 via laser. In this way, the light-transmitting property and recognition of each three-dimensional pattern 121 can be increased.

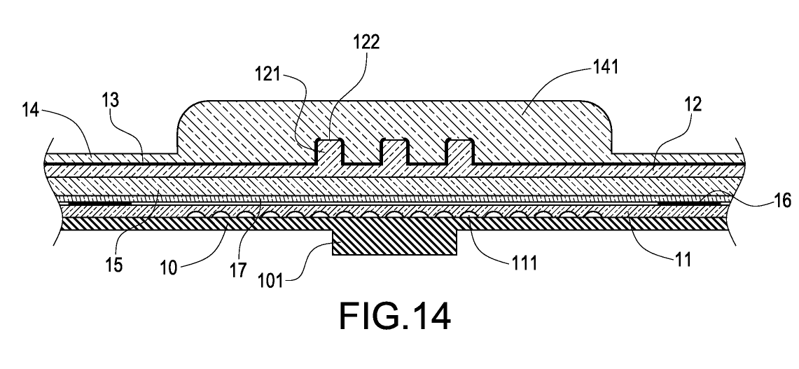

Moreover, after the above step k), the method of the present invention includes a step l). of printing the bottom surface of the shaping layer 15 with a colored light-transmitting film 17 (FIG. 13). In this step, the bottom surface of the shaping layer 15 is printed with a colored light-transmitting film 17 so as to display variable colors on the pattern layer 12 because the color of the colored light-transmitting film 17 can be suitably selected according to various demands. FIG. 14 shows the keypad manufactured by the additional steps k) and 1) of the present invention.

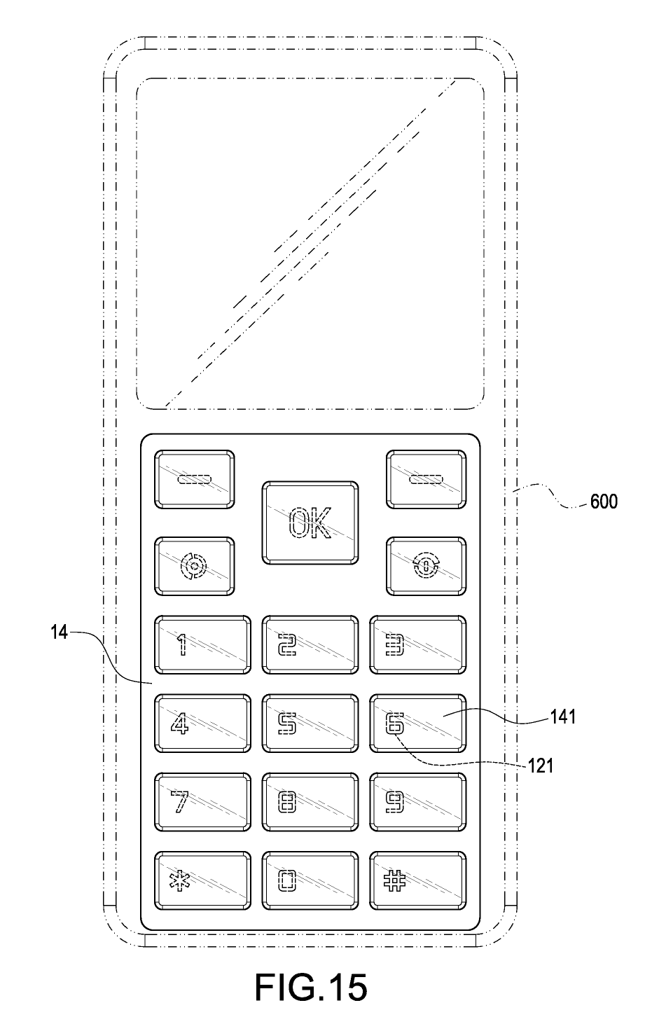

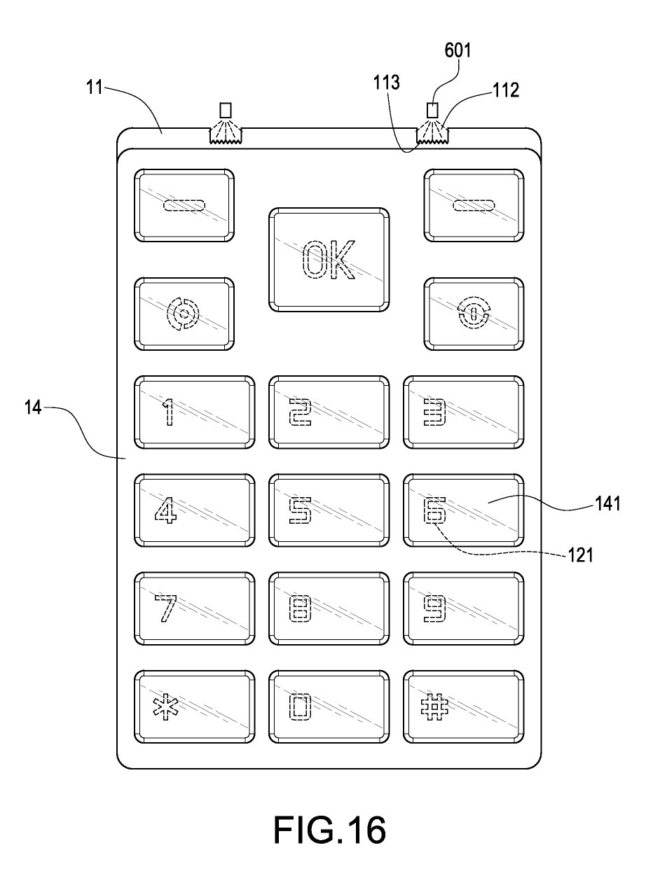

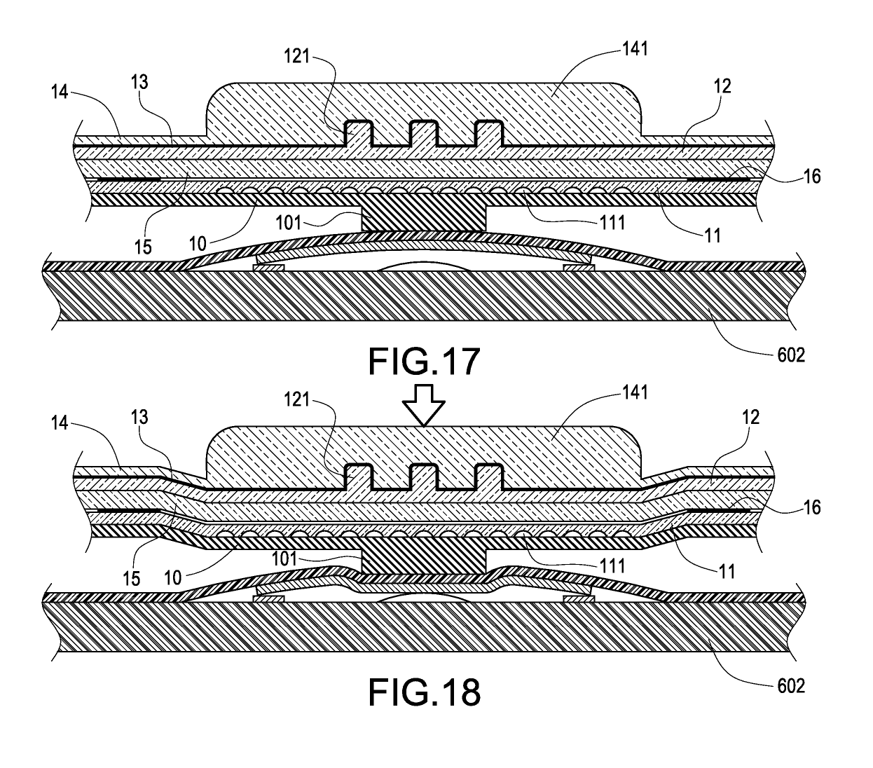

Please refer to FIGS. 15 to 18. FIG. 15 is an assembled view showing the key of the present invention being used in a mobile phone. FIG. 16 is a schematic view showing the arrangement of the key of FIG. 15 and light-emitting elements. FIG. 17 is an assembled cross-sectional view showing the state before the action of the key of FIG. 16 and a circuit board. FIG. 18 is an assembled cross-sectional view showing the state after the action of the key of FIG. 16 and the circuit board. The key of the present invention can be used in a mobile phone 600. Light-emitting elements 601 (FIG. 16) and a circuit board 602 (FIG. 17) are arranged on the mobile phone 600. The two notches 112 of the light-guiding plate 11 are arranged to correspond to the light-emitting elements 601. The tooth-like stripes 113 are used to increase the ratio and uniformity of the light of the light-emitting elements 601 entered the light-guiding plate 11. In use, pressing the keycap 141 can contact a conductive terminal of the circuit board 602 via the bump 101 of the base layer 10, thereby generating a corresponding trigger signal.

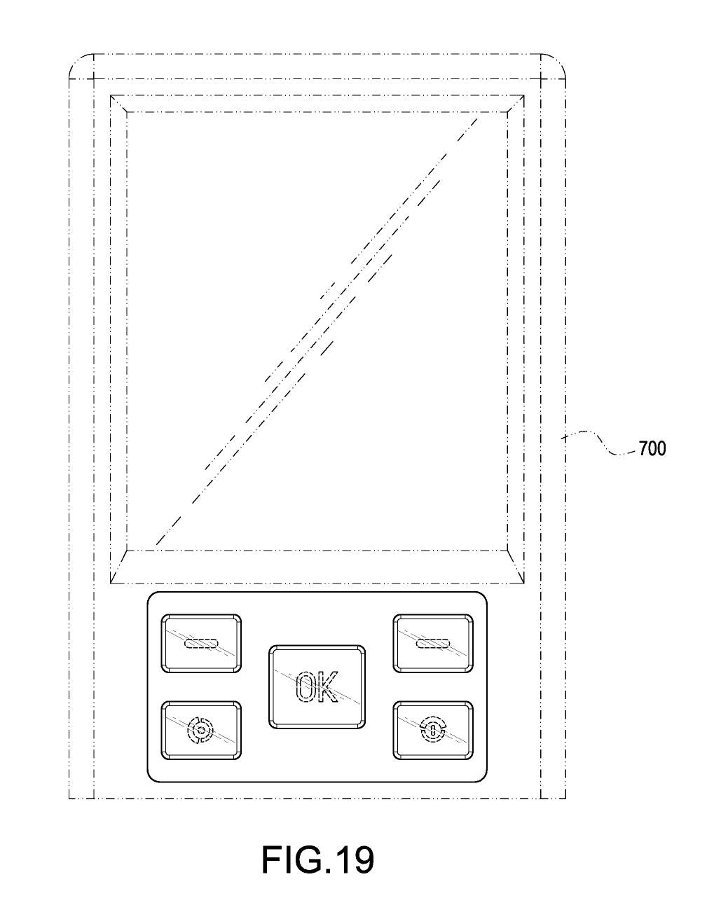

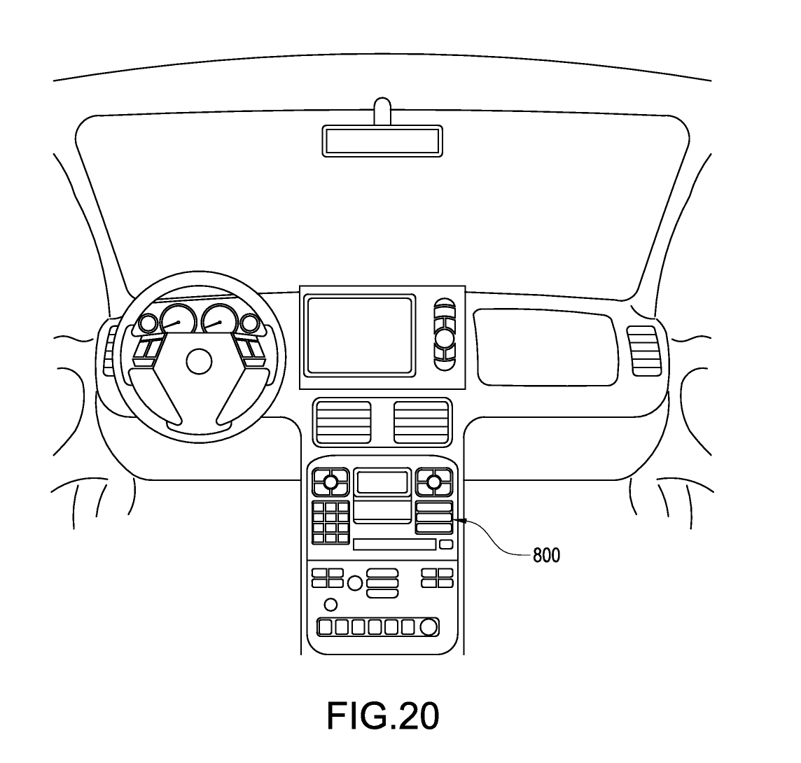

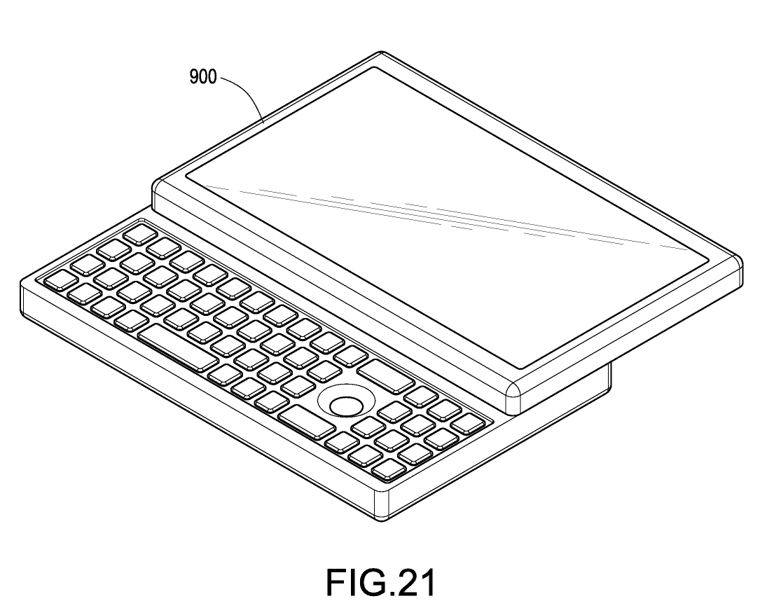

Please refer to FIGS. 19 to 21. FIG. 19 is an assembled schematic view showing the key of the present invention being used in a PDA. FIG. 20 is an assembled schematic view showing the key of the present invention being used in an automobile stereo panel. FIG. 21 is an assembled schematic view showing the key of the present invention being used in a UMPC. In addition to the mobile phone 600, the present invention can be also used in the keypad of a personal digital assistant (PDA) 700 as shown in FIG. 18, an automobile stereo panel 800 as shown in FIG. 19, or an ultra-mobile personal computer (UMPC) 900 as shown in FIG. 20.

According to the above, the present invention really has industrial applicability, novelty and inventive steps, and has not been seen in products of the same kind or let used in public. Therefore, the present invention conforms to the requirements for an invention patent.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A method for manufacturing keypad having three-dimensional patterns, comprising the steps of;
a) preparing a first mold, and filling a first ultra-violet curable resin in the first mold;
b) disposing a shaping layer in the first mold, and overlapping the shaping layer on the first ultra-violet curable resin;
c) irradiating the first ultra-violet curable resin with an ultra-violet lamp to cure the resin to form a pattern layer, forming a plurality of three-dimensional patterns on a front surface of the pattern layer;
d) removing an assembled structure having the shaping layer and the pattern layer from the first mold;
e) coating a coating layer on a front surface of the pattern layer, thereby forming a semi-finished key;
f) preparing a second mold, and filling a second ultra-violet resin into the second mold;
g) disposing the semi-finished key in the second mold and overlapping it on the second ultra-violet curable resin; and
h) irradiating the second ultra-violet curable resin with the ultra-violet lamp to cure the resin to form a keycap layer, and forming a plurality of keycaps on a front surface of the keycap layer.

2. The method according to claim 1, wherein the coating layer is coated in the step e) by means of physical vapor deposition, sputtering, or multilayer coating.

3. The method according to claim 1, wherein the three-dimensional patterns are embedded in the second ultra-violet curable resin respectively in the step g).

4. The method according to claim 1, wherein a step k) is performed after the step e), and a portion of the coating layer on the three-dimensional patterns is removed by laser in the step k).

5. The method according to claim 1, further comprising a step l) of printing a colored light-transmitting film on a back surface of the shaping layer.

6. A method for manufacturing keypad having three-dimensional patterns, comprising the steps of;
a) preparing a first mold, and filling a first ultra-violet curable resin in the first mold;
b) disposing a shaping layer in the first mold, and overlapping the shaping layer on the first ultra-violet curable resin;
c) irradiating the first ultra-violet curable resin with an ultra-violet lamp to cure the resin to form a pattern layer, forming a plurality of three-dimensional patterns on a front surface of the pattern layer;
d) removing an assembled structure having the shaping layer and the pattern layer from the first mold;
e) coating a coating layer on a front surface of the pattern layer, thereby forming a semi-finished key;
f) preparing a second mold, and filling a second ultra-violet resin into the second mold;
g) disposing the semi-finished key in the second mold and overlapping it on the second ultra-violet curable resin;
h) irradiating the second ultra-violet curable resin with the ultra-violet lamp to cure the resin to form a keycap layer, and forming a plurality of keycaps on a front surface of the keycap layer; and
i) overlapping a light-guiding plate on a back surface of the shielding layer.

7. The method according to claim 6, wherein the coating layer is coated in the step e) by means of physical vapor deposition, sputtering, or multilayer coating.

8. The method according to claim 6, wherein the three-dimensional patterns are embedded in the second ultra-violet curable resin respectively in the step g).

9. The method according to claim 6, wherein the step i) is performed after the step e).

10. The method according to claim 6, wherein the step i) is performed after the step h).

11. The method according to claim 6, wherein a step k) is performed after the step e), and a portion of the coating layer on the three-dimensional patterns is removed by laser in the step k).

12. The method according to claim 6, further comprising a step 1) of printing a colored light-transmitting film on a back surface of the shaping layer.

13. A method for manufacturing keypad having three-dimensional patterns, comprising the steps of;
a) preparing a first mold, and filling a first ultra-violet curable resin in the first mold;
b) disposing a shaping layer in the first mold, and overlapping the shaping layer on the first ultra-violet curable resin;
c) irradiating the first ultra-violet curable resin with an ultra-violet lamp to cure the resin to form a pattern layer, forming a plurality of three-dimensional patterns on a front surface of the pattern layer;
d) removing an assembled structure having the shaping layer and the pattern layer from the first mold;
e) coating a coating layer on a front surface of the pattern layer, thereby forming a semi-finished key;
f) preparing a second mold, and filling a second ultra-violet resin into the second mold;
g) disposing the semi-finished key in the second mold and overlapping it on the second ultra-violet curable resin; and
h) irradiating the second ultra-violet curable resin with the ultra-violet lamp to cure the resin to form a keycap layer, and forming a plurality of keycaps on a front surface of the keycap layer;
i) overlapping a light-guiding plate on a back surface of the shielding layer; and
j) connecting a base layer to a back surface of the light-guiding plate by means of pressing.

14. The method according to claim 13, wherein the coating layer is coated in the step e) by means of physical vapor deposition, sputtering, or multilayer coating.

15. The method according to claim 13, wherein the three-dimensional patterns are embedded in the second ultra-violet curable resin respectively in the step g).

16. The method according to claim 13, wherein the step i) is performed after the step e).

17. The method according to claim 13, wherein the step i) is performed after the step h).

18. The method according to claim 13, wherein the light-guiding plate is connected to the base layer via a hot pressing process in the step i).

19. The method according to claim 13, wherein a step k) is performed after the step e), and a portion of the coating layer on the three-dimensional patterns is removed by laser in the step k).

20. The method according to claim 13, further comprising a step l) of printing a colored light-transmitting film on a back surface of the shaping layer.
